(19) United States
(12) Patent Application Publication
(10) Pub. No.: US 2020/0158225 A1
(43) Pub. Date: May 21, 2020

(54) Floating Drive System and its Floating Drive Disc and Floating Flywheel

(71) Applicant: Yung-Sheng Wang, Taipei City (TW)

(72) Inventor: Yung-Sheng Wang, Taipei City (TW)

(21) Appl. No.: 16/555,218

(22) Filed: Aug. 29, 2019

(30) Foreign Application Priority Data
Nov. 21, 2018 (TW) 107141411

(51) Int. Cl. F16H 55/30; F16D 41/26; F16D 65/12

(52) U.S. Cl. CPC F16H 55/303; F16H 2055/306; F16D 65/123; F16D 41/26

(57) ABSTRACT

A floating drive system includes a floating disc and a floating flywheel, when the chain is offset on the floating flywheel, the floating disc is yawed on each sleeved disc axle, and the floating flywheel is yawed on the sleeved flywheel axle to maintain the linear offset of the chain.

### CROSS REFERENCE TO RELATED APPLICATION

This application claims the benefit of and takes priority from Taiwan Patent Application No. 107141411 filed on Nov. 21, 2018, the contents of which are herein incorporated by reference.

### BACKGROUND OF THE INVENTION

### 1. Field of the Invention

The present invention relates generally to a drive system, and more particularly to a floating drive system and its floating drive disc and floating flywheel.

### 2. Description of Related Art

The bicycle is equipped with a driving gear and a driven gear, and two gears are arranged around the chain to form a drive device, and the pedal at the end of the crank provided at the side end of the driving gear enables the driving gear to drive the chain and the driven gear to rotate, and the wheel body disposed on the driven gear shaft can be rotated, so that the bicycle can obtain the forward power.

The force required by the bicycle structure is different in gear ratio, which constitutes the effect of easy pedaling or high torsion. Moreover, in the pedaling process, when the pedal is located at the apex of its rotational movement and slightly ahead in the middle, the rider can easily apply downward force, and this force can generate a fairly effective torque for the driving gear. Moreover, when the pedal is at the middle bottom end, only a slight effect or even no torque is applied to the driving gear, so that the rotation of the two pedals and the alternate up and down movement will cause one side pedal to have a half-circle stroke force and a half-circle stroke rest, and the pedal on the other side is at a relative half-circle stroke rest and a half-circle stroke rest. Therefore, after the gear ratio of the driving gear and the driven gear is set, whether the pedaling force is easy depends on the gear ratio.

As for the chain around the general driving gear and the chain on the driven gear, regardless of whether it is easily pedaled by the force, which only is gently pedaling of circular motion, but the instantaneous gear ratio change can not be generated in a pedaling stroke, and even in the speed-variable bicycle, the chain must complete the climbing and shifting, in this way the different gear ratio can be changed. Generally, the chain will be bend when the chain is offset in shifting, which will cause power loss and reduce the chain service life.

### SUMMARY OF THE INVENTION

The present invention provides a floating drive system, comprising: a floating disc, a crank, a plurality of the disc axle surrounding the outer ring of the crank, a fluted disc connected to the outer ring of the crank, and a plurality of the disc axle sleeve respectively sleeved on the outside of each disc axle disposed around inside of the fluted disc; and a floating flywheel, comprising a axle hole and a ratchet seat disposed in the axle hole, wherein the outside of the ratchet seat is provided with a flywheel axle integrated with or separated from the ratchet seat, a curved surface is formed at the outside of the flywheel axle, the outside of the flywheel axle is connected to a flywheel axle sleeve, the flywheel axle sleeve contacts the curved surface, and a yaw space is formed between the two sides of the flywheel axle sleeve and the two sides of the curved surface; wherein, when a chain is offset on the floating flywheel, each disc axle sleeved on the floating disc is yawed, and the floating flywheel is yawed on the sleeved flywheel axle to maintain the chain is linearly offset.

In an embodiment, each disc axle includes a through hole, and the floating disc includes an upper cover that is fixed to each disc axle.

In an embodiment, wherein the floating flywheel includes a plurality of fixed pins, each fixed pin is locked with the flywheel axle sleeve outer ring and the flywheel axle outer ring in ring array.

In an embodiment, wherein the floating flywheel includes a flywheel cover covered on the flywheel axle sleeve.

In an embodiment, wherein the floating flywheel includes a flywheel axle cover covered on the flywheel axle.

The present invention also provides a floating drive disc, comprising: a floating disc, a crank, a plurality of disc axles around the crank outer ring, a fluted disc connected to the crank outer ring, the inside of the fluted disc is provided with a plurality of disc axle sleeves respectively sleeved on the outside of each disc axle.

In an embodiment, wherein each disc axle includes a through hole, and the floating disc includes an upper cover fixed to each disc axle.

The present invention also provides a floating flywheel, including: a floating flywheel, an axle hole and a ratchet seat disposed in the axle hole, the outside of the ratchet seat is provided with a flywheel axle integrated or separated from the ratchet seat, a curved surfaces is formed on the outside of the flywheel axle, and the outside of the flywheel axle is sleeved with a flywheel axle sleeve, and the flywheel axle sleeve contacts the curved surface, and a yaw space is formed between two sides of the flywheel axle sleeve and two sides of the curved surface.

In an embodiment, a plurality of fixed pins is included, and each fixed pin is locked with the outer ring of the flywheel axle sleeve and the outer ring of the flywheel axle in ring array.

In an embodiment, including a flywheel cover covered on the flywheel axle sleeve, and a flywheel axle cover covered on the flywheel axle.

In an embodiment of the present invention, a floating disc and a floating flywheel drive system are used to reduce the power loss caused by the offset bent chain and prolong the service life of the chain.

### BRIEF DESCRIPTION OF THE DRAWINGS

FIG. 1 is a schematic diagram of the floating drive system according to an embodiment of the present invention.

FIG. 2 is a schematic diagram of the floating disc according to an embodiment of the present invention.

FIG. 3 is a decomposition schematic diagram of the floating disc according to an embodiment of the present invention.

FIG. 4 is a side schematic diagram of the floating disc according to an embodiment of the present invention.

FIG. 5 is a decomposition schematic diagram of the floating flywheel according to an embodiment of the present invention.

FIG. 6 is a side schematic diagram of the floating flywheel according to an embodiment of the present invention.

FIG. 7 is a top schematic diagram of the floating flywheel according to an embodiment of the present invention.

FIG. 8 is a schematic diagram of the chain moved to the maximum position of the flywheel according to an embodiment of the present invention.

FIG. 9 is a schematic diagram of the chain in the horizontal alignment according to an embodiment of the present invention.

FIG. 10 is a schematic diagram of the chain moved to the minimum position of the flywheel according to an embodiment of the present invention.

### DETAILED DESCRIPTION OF THE SEVERAL EMBODIMENTS

In order to make the purpose, technical characteristics and advantages of the present invention more known to the people in relevant technical fields and to implement the present invention, the technical characteristics and implementation methods of the present invention are described in the following instructions in conjunction with the attached illustration, and better embodiments are listed for further explanation, although the following embodiments are not intended to limit the present version, and the comparison illustration hereinafter is an indication of the characteristics of the present invention.

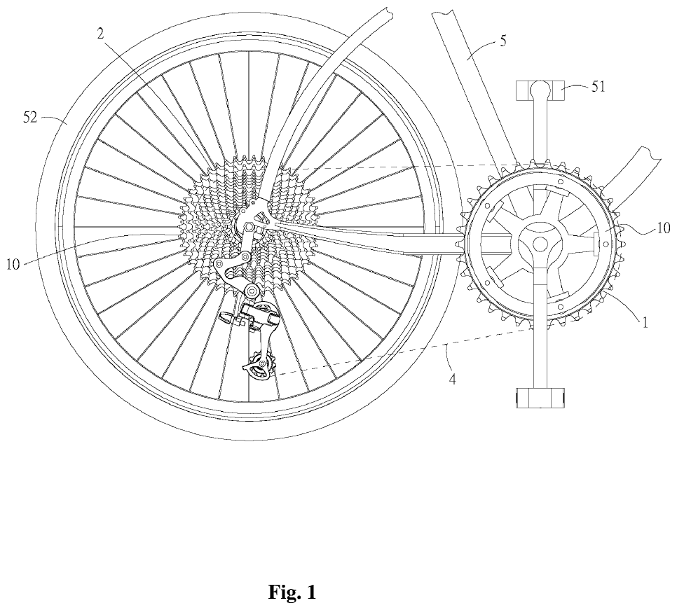

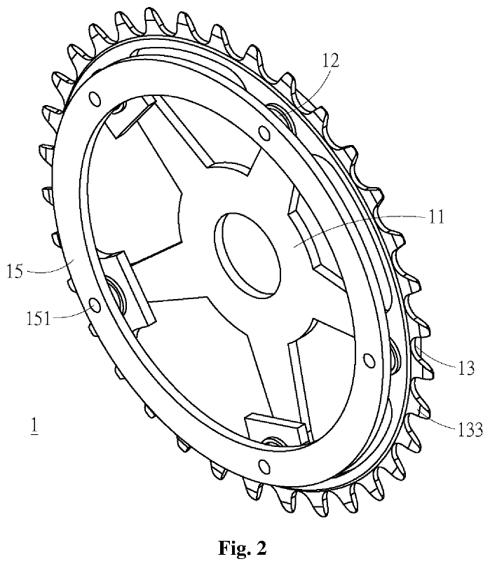

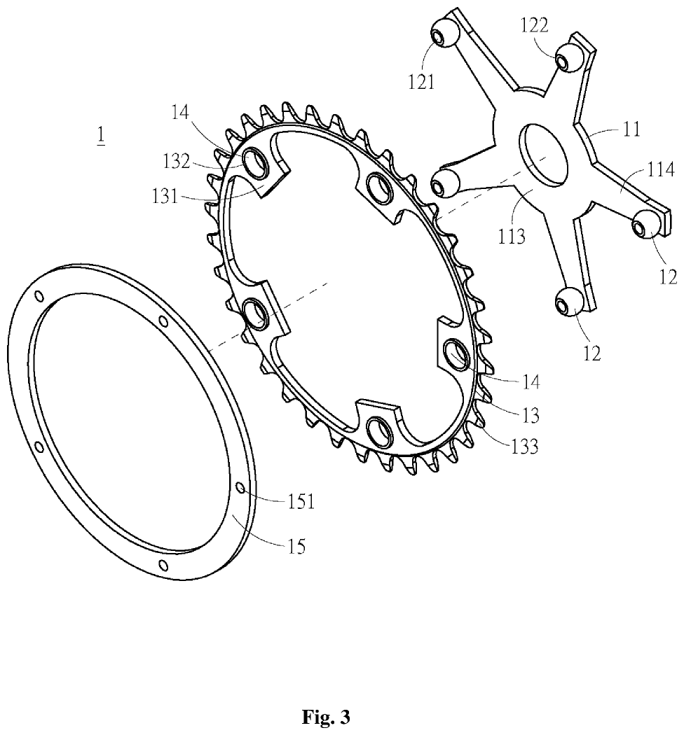

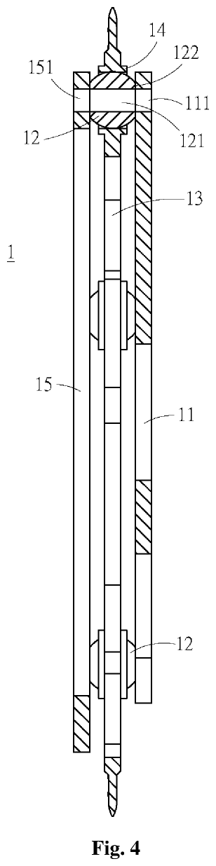

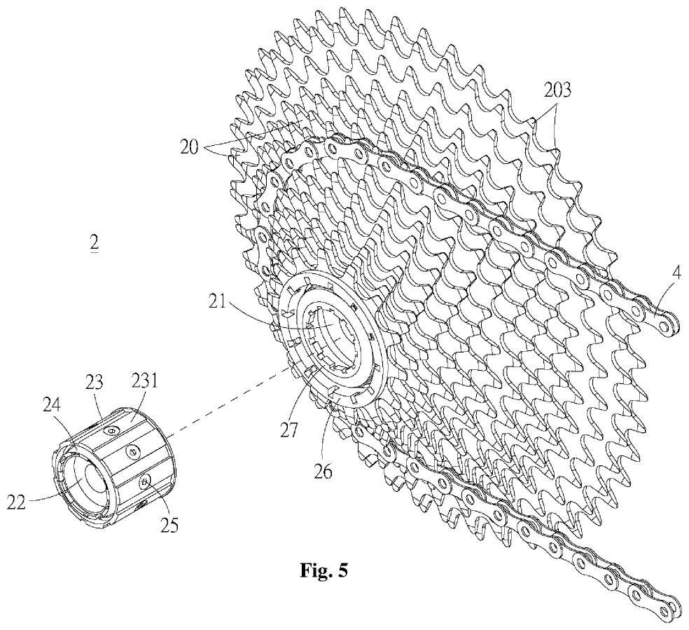

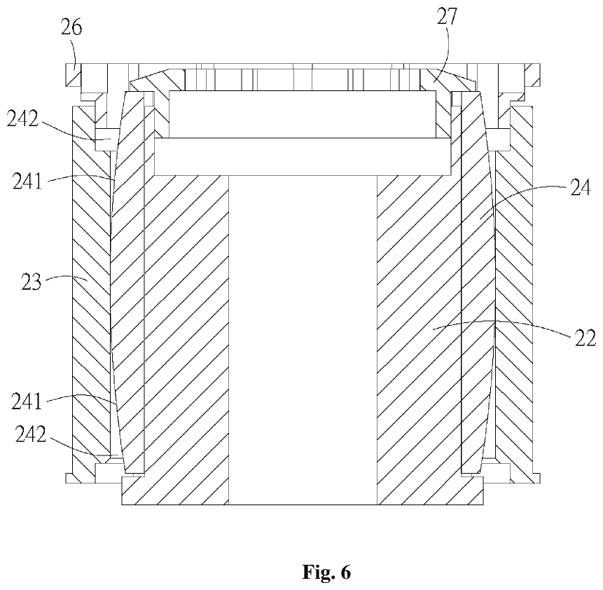

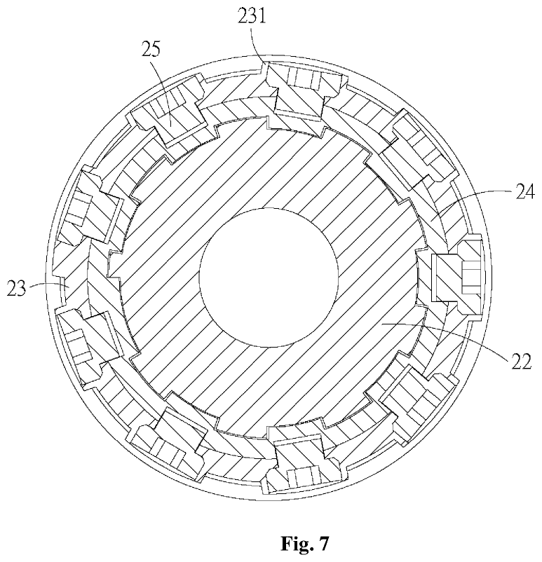

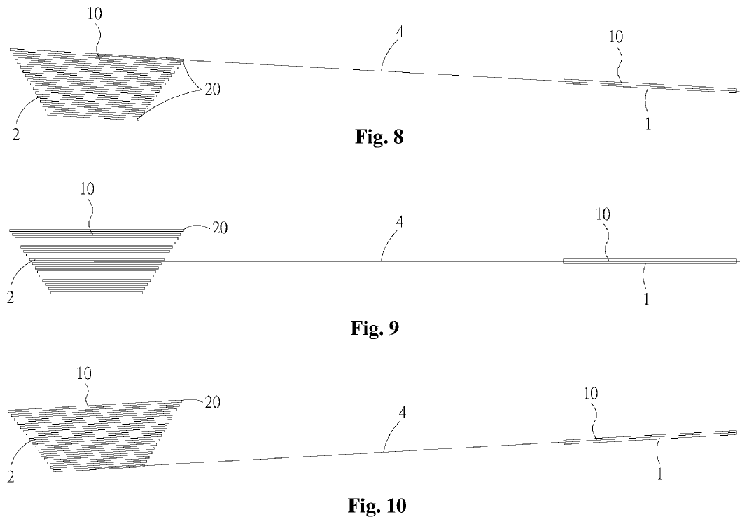

Referring to FIGS. 1 to 10, FIG. 1 is a schematic diagram of the floating drive system. FIG. 2 is a schematic diagram of the floating disc. FIG. 3 is a decomposition schematic diagram of the floating disc. FIG. 4 is a side schematic view of the floating disc. FIG. 5 is a decomposition schematic diagram of the folding flywheel. FIG. 6 is a side schematic diagram of the floating flywheel. FIG. 7 is a top schematic diagram of the floating flywheel. FIG. 8 is a schematic diagram of the chain moved to the maximum position of the flywheel. FIG. 9 is a schematic diagram of the chain in the horizontal alignment. FIG. 10 is t is a schematic diagram of the chain moved to the minimum position of the flywheel. The chain 4 in FIG. 1 is indicated by a point chain line, the chain 4 in FIG. 8-FIG. 10 is indicated by a line, and the actual chain 4 is as shown in FIG. 5.

In this embodiment, the floating drive system 10 includes a floating disci and a floating flywheel 2. The floating drive system 10 is used in a bicycle 5 or the sports equipment, etc., the floating disc 1 is a driving gear, the floating disc 1 is installed at a position of the pedal 51, and the floating flywheel 2 is a driven gear, floating flywheel 2 is installed at a position of the rear wheel 52.

In this embodiment, the drive device is formed by two gears of the floating disc 1 and the floating flywheel 2 encircled by the chain 4, and the pedal 51 at the tail end of the crank 11 disposed at the side end of the floating disc 1 (driving gear) is used to make the floating disc 1 (driving gear) drive the chain 4 and the floating flywheel 2 (driven gear), and the wheel body disposed on the floating flywheel 2 (driven gear) axle can be rotated, so that the bicycle 5 can obtain the forward power.

In this embodiment, the floating disc 1 includes a crank 11, a plurality of disc axles 12 around the outer ring of the crank 11, a fluted disc 13 connected to the outer ring of the crank 11, and a plurality of the gear 133 protruded from the outer ring of the fluted disc 13 for connecting the chain 4. The crank 11 includes a torus 113 and an extension sheet 114 of the torus 113 in ring array.

In this embodiment, the inside of the fluted disc 13 is provided with a plate block 131. Each plate block 131 is formed with a plurality of holes 132, and a plurality of disc axle sleeves 14 is fixed in the holes 132. The disc axle sleeves 14 are respectively sleeved outside the disc axles 12. Thus, the disc axle sleeve 14 is a tubular structure, and further, the disc axle sleeve 14 and the fluted disc 13 may be an integral structure or a two-piece structure.

In this embodiment, the disc axle 12 is a spherical structure for that the disc axle sleeve 14 is sleeved. The outer diameter of the disc axle 12 is equal to the inner diameter of the disc axle sleeve 14. The fluted disc 13 is sleeved on the disc axle 12 via the disc axle sleeve 14 and it can be offset in shifting.

In this embodiment, the floating flywheel 2 includes a disc 20 forming a plurality of gear 203, each of which is arranged in order from large to small, each disc 20 is arranged in a tapered shape, and the chain 4 switched from the large disc 20 to the small disc 20 provides a variable speed function.

In this embodiment, the center of each disc 20 of the floating flywheel 2 includes an axle hole 21 and a ratchet seat 22 disposed in the axle hole 21, the ratchet seat 22 is a hollow tube body, and the outside of a ratchet seat 22 is provided with a flywheel axle 24 integrated or separated from the ratchet seat 22, the outside of the flywheel axle 24 is connected with a flywheel axle sleeve 23, the flywheel axle sleeve 23 is a hollow sleeve structure, and the outer surface of the flywheel axle sleeve 23 is annularly arranged with a plurality of protrusion blocks 231.

In this embodiment, the outside of the ratchet seat 22 is connected to a flywheel axle 24, and the ratchet seat 22 and the flywheel axle 24 are combined in a two-piece structure, but not limited thereto. In some embodiments, the ratchet seat 22 and the flywheel axle 24 may be an integral structure, the ratchet seat 22 and flywheel axle 24 are processed into a same structure, and then the outside of the flywheel axle 24 is connected with the flywheel axle sleeve 23.

In this embodiment, a curved surface 241 is formed on the outside of the flywheel axle 24, and the flywheel axle sleeve 23 contacts the curved surface 241. A yaw space 242 is formed between two sides of the flywheel axle sleeve 23 and two sides of the curved surface 241, and the outside of the conventional flying shaft 24 is flat and contacts the inside of the flywheel axle sleeve 23, and it cannot be yawed. In this embodiment, the flywheel axle sleeve 23 is sleeved on the curved surface 241 of the flywheel axle 24, and the flywheel axle sleeve 23 can be yawed along the curved surface 241, that is, a yaw space 242 is formed between two sides of the flywheel axle sleeve 23 and two sides of the curved surface 241. When the flywheel axle sleeve 23 is yawed on the left and right sides as well as upper and lower sides, it can be moved to the yaw space 242 along the curved surface 241.

In this embodiment, the flywheel axle 24 is a spherical structure for that the flywheel axle sleeve 23 is sleeved. The outer diameter of the flywheel axle 24 is equal to the inner diameter of the flywheel axle sleeve 23. Each disc 20 of the floating flywheel 2 is sleeved on the flywheel axle 24 via the flywheel axle sleeve 23, and it can be offset in shifting.

In this embodiment, each disc axle 12 includes a through hole 121, and the floating disc 1 includes an upper cover 15 fixed to each disc axle 12.

In this embodiment, when a chain 4 is offset on the floating flywheel 2, the floating disc 1 is yawed on each sleeved disc axles 12, and the floating flywheel 2 is yawed on the sleeved flywheel axle 24 to maintain the chain 4 in straight line offset.

That is to say, a plurality of spherical disc axles 12 and a tubular disc axle sleeve 14 is used for that the fluted disc 13 is yawed and also it can transmit the power, and the upper cover 15 is fixed to prevent the disc axle 12 from shaking. That is, the spherical flywheel axle 24 is sleeved on the ratchet seat 22, and the tubular flywheel axle sleeve 23 can be yawed on the spherical flywheel axle 24; the fixed pin 25 can limit the position of the tubular flywheel axle sleeve 23 and transmits the kinetic energy of the flywheel to the ratchet seat 22.

In this embodiment, the crank 11 includes a plurality of lockholes 111, and they are aligned with the through holes 121 of the disc axles 12. The upper cover 15 includes a plurality of lockholes 151, and they are aligned with the through holes 121 of the disc axles 12.

In this embodiment, two sides of each disc axle 12 respectively form a plane 122 affixed to the crank 11 and the upper cover 15.

In this embodiment, the floating flywheel 2 includes a plurality of fixed pins 25, each fixed pin 25 ring array is locked to the outer ring of the flywheel axle sleeve 23 and the outer ring of the flywheel axle 24. In particular, each fixed pin 25 is locked by each protrusion block 231 of the outer surface of the flywheel axle sleeve 23. Moreover, each fixed pin 25 is locked in the transverse central axis of the flywheel axle 24, to restrict the flywheel axle sleeve 23 and the movement of the disc 20 on the flywheel axle sleeve 23, that is, to restrict the offset position of the floating flywheel 2.

In this embodiment, the floating flywheel 2 includes a flywheel cover 26 covered on the flywheel axle sleeve 23.

In this embodiment, the floating flywheel 2 includes a flywheel axle cover 27 covered on the flywheel axle 24.

In this embodiment, the chain 4 can be located in the middle of the floating flywheel 2, and the chain 4 is in a straight line.

In this embodiment, when the shifting is switched, the chain 4 can be located at the minimum position of the floating flywheel 2 (the smallest disc 20), the chain 4 is still in a straight line, the driving is yawed counterclockwise in the floating disc 1, and, the spherical disc axle 12 at one side of the floating disc 1 will be exposed, and the disc axle sleeve 14 at the other side of the floating disc 1 will lean against the crank 11.

In this embodiment, when the shifting is switched, the chain 4 can be located at the maximum position of the floating flywheel 2 (the largest disc 20), the chain 4 is still in a straight line, the driving is yawed clockwise in the floating disc 1, and, the disc axle sleeve 14 at one side of the floating disc 1 will lean against the crank, and the spherical disc axle 12 at the other side of the floating disc 1 will be exposed.

In this embodiment, the chain 4 is at the minimum position of the floating flywheel 2 (the smallest disc 20), and the floating flywheel 2 will be counter-clockwise yawed by the pulling force, and vice versa at the maximum position (the largest disc 20).

In an embodiment of the present invention, a floating disc and a floating flywheel drive system are used to reduce the power loss caused by the bent chain offset and prolong the service life of the chain.

Although the present invention has been disclosed in the foregoing preferred embodiments, it is not intended to limit the present invention, and those skilled in the art can make some modifications and refinements without departing from the spirit and scope of the present invention. Therefore, the scope of patent protection of this invention shall be subject to the scope definition of the patent application attached to this specification.

What is claimed is:

1. A floating drive system comprising:
a floating disc, comprising a crank, a plurality of disc axles around the outer ring of the crank, a fluted disc connected to the outer ring of the crank, inside of the fluted disc is provided with a plurality of the disc axle sleeves respectively sleeved on outside of the disc axles;
a floating flywheel, comprising an axle hole and a ratchet seat disposed in the axle hole, outside of the ratchet seat is provided with a flywheel axle integrated or separated from the ratchet seat, a curved surface is formed on the outside of the flywheel axle, the outside of the flywheel axle is sleeved on a flywheel axle sleeve, the flywheel axle sleeve contacts the curved surface, and a yaw space is formed between two sides of the flywheel axle sleeve and two sides of the curved surface;
wherein, when a chain is offset on the floating flywheel, the floating disc is yawed on each sleeved disc axle, and the floating flywheel is yawed on the sleeved flywheel axle to maintain the chain in linear offset.

2. The floating drive system as claimed in claim 1, wherein the disc axle includes a through hole, and the floating disc includes an upper cover fixed to each disc axle.

3. The floating drive system as claimed in claim 1, wherein the floating flywheel includes a plurality of fixed pins, each fixed pin ring array is locked to the outer ring of the flywheel axle sleeve and the outer ring of the flywheel axle.

4. The floating drive system as claimed in claim 1, wherein the floating flywheel includes a flywheel cover covered on the flywheel axle sleeve.

5. The floating drive system as claimed in claim 1, wherein the floating flywheel includes a flywheel axle cover covered on the flywheel axle.

6. A floating flywheel includes an axle hole and a ratchet seat disposed in the axle hole, and the outside of the ratchet seat is provided with a flywheel axle integrated or separated from the ratchet seat, and a curved surface is formed on the outside of the flywheel axle, the outside of the flywheel axle is connected to a flywheel axle sleeve, and the flywheel axle sleeve contacts the curved surface, and a yaw space is formed between two sides of the flywheel axle sleeve and two sides of the curved surface.

7. The floating flywheel as claimed in claim 6, includes a plurality of fixed pins, each fixed pin ring array is locked to the outer ring of the flywheel axle sleeve and the outer ring of the flywheel axle.

8. The floating flywheel as claimed in claim 6, wherein said flywheel further comprises a flywheel cover covered on the flywheel axle sleeve, and a flywheel axle cover covered on the flywheel axle.
